(19) United States
(12) Patent Application Publication
(10) Pub. No.: US 2010/0320343 A1
(43) Pub. Date: Dec. 23, 2010

(54) TWO-LEVEL CLAMP FOR PHOTOVOLTAIC MODULES

(75) Inventor: BERNHARD BECK, Volkach (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Adensis GmbH, Dresden (DE)

(21) Appl. No.: 12/790,071

(22) Filed: May 28, 2010

(30) Foreign Application Priority Data
Jun. 18, 2009 (DE) 10 2009 025 365.3

(51) Int. Cl. F16M 13/02; B23P 17/04

(52) U.S. Cl. 248/226.11; 29/428

(57) ABSTRACT

A clamp for attaching rectangular photovoltaic modules on a module rail is constructed so that the upper edge of a first module can be installed at a greater height than the lower edge of a second module. The upper edge of the first module rests on a first supporting surface and the lower edge of the second module rests on a second supporting surface, with the both supporting surfaces disposed on a base and having the same slope. The edges of the modules are affixed on the supporting surfaces by way of a bracket (5). The design of the clamp prevents formation of hollow spaces through which melt water can enter, but from which it cannot drain.

### CROSS-REFERENCES TO RELATED APPLICATIONS

This application claims the priority of German Patent Application, Serial No. 10 2009 025 365.3, filed Jun. 18, 2009, pursuant to 35 U.S.C. 119(a)-(d), the content of which is incorporated herein by reference in its entirety as if fully set forth herein.

### BACKGROUND OF THE INVENTION

The invention relates to a clamp for inclined attachment of rectangular photovoltaic modules on a module rail, wherein the upper edge of a first module can be mounted at a greater height than the lower edge of a second module.

The following discussion of related art is provided to assist the reader in understanding the advantages of the invention, and is not to be construed as an admission that this related art is prior art to this invention.

Clamps of this type are used to attach the photovoltaic modules with a small slope on horizontally extending module rails on flat roofs or roofs with supporting structures, while simultaneously improve the incident angle of the sun rays on the photovoltaic modules. For example, EP-A-0 531 869 discloses a clamp, where the upper edge of the first module is inserted into a first slot in the clamp. The lower edge of the second PV module is inserted in a second slot located below the first opening and oriented in the opposite direction. With this construction of the clamp, however, during the winter water from molten snow can disadvantageously enter between the modules and the slots, where it freezes again. This can mechanically damage the clamp or the module. In addition, the module surface is not optimally used at a low altitude of the sun, because the upper edge of the first module casts a shadow on the lower region of the second photovoltaic module, or the modules must be provided with an unfavorable broad edge.

It would therefore be desirable and advantageous to provide an improved clamp to obviate prior art shortcomings by preventing damage to the clamp and the modules due to freezing melt water and to prevent shadowing of the lower edge of the higher module by the upper edge of the lower module at a low altitude of the sun for modules, which are inclined with respect to the incident sun rays.

### SUMMARY OF THE INVENTION

According to one aspect of the invention, a clamp for inclined attachment of rectangular photovoltaic modules on a module rail, with an upper edge of a first photovoltaic module mounted at a greater height than a lower edge of a second photovoltaic module, includes a base having a bottom side and a first support constructed to receive the upper edge of the first photovoltaic module and a second support constructed to receive the lower edge of a second photovoltaic module, and a bracket constructed to attach the upper edge of the first photovoltaic module to the first support and to attach the lower edge of a second photovoltaic module to the second support, wherein the first and the second support are each implemented as at least one of a supporting surface, a supporting line or a supporting point, and wherein the first and the second support, when projected onto the bottom side, are spaced from each other, so that a higher marginal region of the first support has a predetermined spacing to a lower marginal region of the second support, thereby inclining of the photovoltaic module with the bracket.

Stated somewhat differently, without reciting the functionality, the clamp is made of a base, which has preferably at planar bottom side, with two supports formed at different heights on the opposite top side, and a bracket having ends which can be pretensioned in the direction toward the supports. The inclination provided by the two-level clamps in addition to the existing slope of the roof improves the angle of incidence when the slope of the roof is not optimized. If the slope of the roof is too large, then the two-level clamp can also be installed reversed, so as to reduce the slope of the photovoltaic module to approach the optimum angle. The spacing A provides likewise optimization, not so much for low positions of the sun, but rather for higher positions of the sun, where the higher module casts a shadow on the lower edge of the lower module when the roofs are too steep. The magnitude of the inclination produced by the clamp depends on the difference in the height of the supports and the width of the PV modules, provided the wider side of the modules is installed along the North-South direction.

The clamp is attached along the module rail for force transmission with uniformly spaced attachment means, so that neither wind nor snow loads can induce movement in the photovoltaic modules. The photovoltaic modules are then placed on the supporting surfaces and pressed against the supporting surfaces with the bracket. In this way, the PV module is affixed so it has limited movement, in order to compensate for temperature variations, bending and the like. By configuring the clamp with supports that are open towards the top, in particular flat, identically inclined supporting surfaces or supports with a spherical top surface, which each provide a supporting point, or supports with a curved cylindrical top surface defining a supporting line, no hollow spaces are formed into which melt water could enter, but from which not melt water could drain, causing it to freeze in the hollow spaces, which can cause the aforementioned damage to the clamp. The term support or supporting surface, which has been used above and will be used hereinafter, always also refers to the cylindrical or spherical shape provided by the supporting line and the supporting point.

For easier installation of the photovoltaic modules, the second supporting surface, line or point for the lower module edge of the second photovoltaic module includes a shoulder operating as a limit stop. The module is moved during the installation until it contacts the limit stop, where the clamp is then positioned. Advantageously, the base and the bracket are preassembled so that only a simple rotation of the bracket over the module edge is required to attain the desired position. The height of the shoulder should be smaller than the height of the photovoltaic module to be installed, thereby once more preventing formation of detrimental hollow spaces. A practical height would be between 3 and 10 mm.

With a clamp having supporting surfaces, the supporting surfaces are configured such that the first and the second deposit surface each have edges oriented parallel to the PV module edge. The clamp is preferably elongated, thereby defining a longitudinal axis, which is aligned in the same direction as the module rail in the installed state. The aforementioned edges of the supporting surfaces are then running transverse to the longitudinal direction. The clamp has a width which preferably corresponds at least to the width of the module rail, in particular if the module rail is implemented as a flat band.

According to an embodiment, the first and the second deposit or supporting surface, point or line, when projected onto the bottom side (and hence in the installed state also onto the module rail), are spaced from one another, so that the higher edge of the first deposit or supporting surface (point, line) has a predetermined distance to the lower edge of the second deposit or supporting surface (point, line). With this approach, even for a low positions of the sun, for example during the winter, the lower edge of the second photovoltaic module is advantageously not shadowed by the upper edge of the first PV module. Such shadowing significantly reduces the efficiency of the entire module, because the individual photovoltaic cells of the module are connected in series and the cell with the weakest incident radiation exhibits the highest electrical resistance.

The distance mentioned in the previous section produces a region on the base which is unobstructed from above, with neither the first nor the second supporting surface impeding its accessibility. The surface area of this region is defined by the predetermined spacing, and the base includes in this region a hole through which a screw, rivet or the like passes, with which the clamp is attached on the module rail. Advantageously, the center portion of the bracket may also include an opening, which is aligned with the hole of the clamp in the installed state. A single screw is sufficient to affix the clamp on the module rail. In this context, the advantage of providing a raised portion on the otherwise flat bottom side of the base should be mentioned. This raised portion may be a cam, a shoulder or any other element which can be suitably inserted, preferably formfittingly, into a mating opening in the module rail. The clamp is then affixed to the module rail by a second point next to the screw to prevent possible displacement or rotation.

Both ends of the bracket are constructed to apply a spring force in the direction of the first supporting surface (line or point) or the second supporting surface (line or point). In the simplest case, this implemented by using an elastic material, for example spring steel, and shaping the ends in the form of an arc. The ends may be provided with a rubber bushing to reduce the friction coefficient between the glass of the PV module and the bracket and to prevent scratching of the module edges.

The photovoltaic modules can be constructed from of unframed glass panes alone, or may have a frame. If a module with a frame is used, then the clamp and the frame should be made of the same material. If the glass is contacted directly, then the selection of the material for the clamp is not critical.

According to a method for producing the base of the clamp, a continuously cast rod with a profile matching the cross-section of the clamp is produced, which is subsequently cut into disks. The clamp can then be produced cost-effectively, which is not true for other conventional clamps.

### BRIEF DESCRIPTION OF THE DRAWING

Other features and advantages of the present invention will be more readily apparent upon reading the following description of currently preferred exemplified embodiments of the invention with reference to the accompanying drawing, in which

FIG. 1 shows a clamp according to the invention with a supporting surface in cross-section;

FIG. 2 shows a clamp according to the invention with supporting point in cross-section;

FIG. 3 shows a perspective view of a clamp with a supporting line; and

FIG. 4 shows a clamp according to the invention with a different shape.

### DETAILED DESCRIPTION OF PREFERRED EMBODIMENTS

Throughout the Figures, same or corresponding elements are generally indicated by same reference numerals. These depicted embodiments are to be understood as illustrative of the invention and not as limiting in any way. It should also be understood that the drawings are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

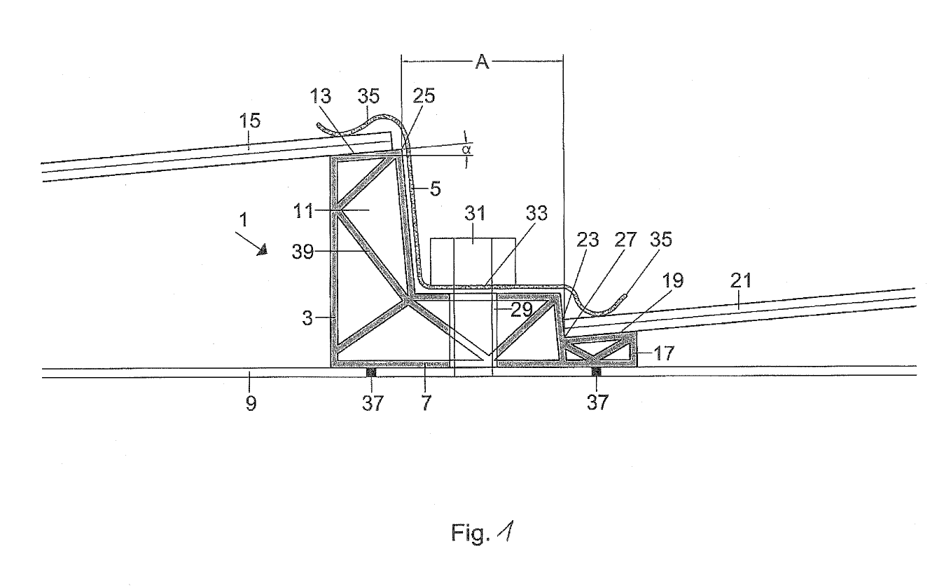

Turning now to FIG. 1, there is shown a clamp 1 includes a base 3 and a bracket 5. The base 3 has a flat bottom side 7 which is configured to rest flat on a module carrier, for example a module rail 9 or a module band (not shown). A tower-shaped raised portion 11 is located on the right side of the base plate with an upper end that is formed as a two-dimensional surface and provides a first supporting surface 13 for a first photovoltaic module 15. The supporting surface 13 is inclined at an angle α with respect to the horizontal.

The right edge of the base 3 has an extension 17 with a bottom surface which forms part of the bottom side 7 and which has a second supporting surface 19 located opposite to the bottom side 7 for receiving a second photovoltaic module 21. The second supporting surface is inclined at the same angle α with respect to the horizontal. The extension 17 is formed integrally with the base 3 and forms a limit stop 23. The limit stop may be higher than the height of the second PV module 21, but may also be lower than the module height. One important feature is the absence of hollow spaces into which melt water can enter, but from which melt water cannot drain.

The first and the second supporting surfaces 13, 19 are located at different heights, causing an inclination of the photovoltaic modules 15, 21. This inclination increases the angle of incidence of the solar radiation onto the modules 15, 21 and thereby improves the efficiency for energy conversion from solar energy into electric energy.

The first or upper supporting surface 13 has an upper edge 25 which extends parallel to the edge of the first PV module 15 and is preferably not covered by the edge of the first PV module 15. After the clamp 1 is installed on the module rail 9, the upper edge 25 of the base 3 should extend transversely to the module rail 9.

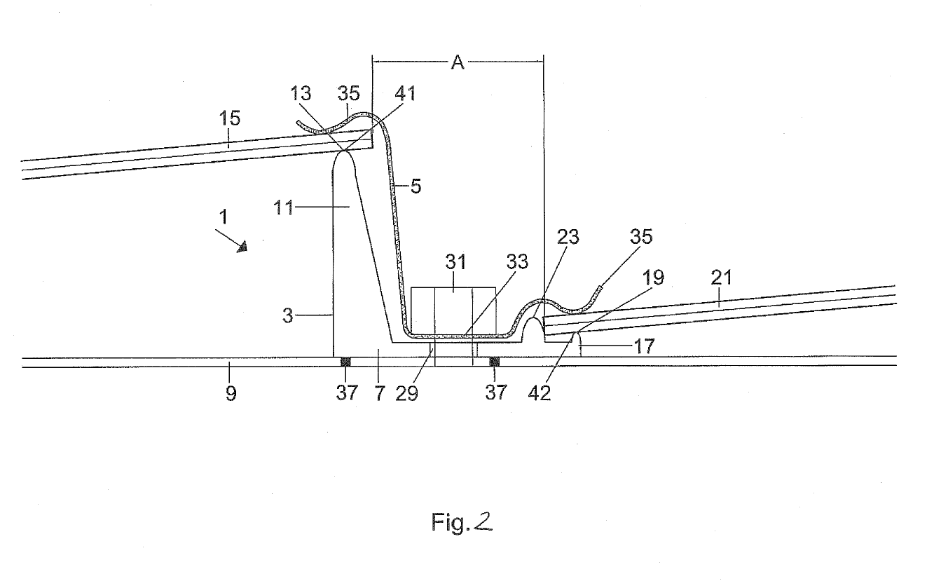

According to the invention, the upper edge 27 is, when projected onto the bottom side 7 of the base 3, spaced from the lower edge 27. This is indicated in FIG. 2 by the distance A, by which the two edges 25, 27 are spaced apart. Accordingly, an intermediate region A with an opening 29 is formed between the two supporting surfaces 13, 19 on the base 3, wherein the opening 29 is freely accessible from above the clamp 1. A screw 31, with which the clamp 1 is attached on the module rail 9, passes through this opening, which can be implemented as a punched hole, a drilled hole and the like.

The bracket 5 has likewise a hole 33 which is aligned with the opening 29, so that the bracket 5 can be installed together with the base 3. The ends of the bracket 5 have each a bow spring 35 dimensioned to press the clamp 1 and of the photovoltaic modules 15, 21 against the supporting surfaces 13, 19 in the installed state. The bracket 5 can be made of suitable spring steel, or of other conventional means providing an elastic spring force.

For rotation-locked attachment of the clamp 3, the bottom side 7 of the clamp 3 may have a cam 37 which formfittingly engages in a corresponding hole (not shown) in the module rail 9. The structure of the base 3 may be stabilized by including cross braces 39, which reduces the overall wall thickness and may allow the use of less expensive materials.

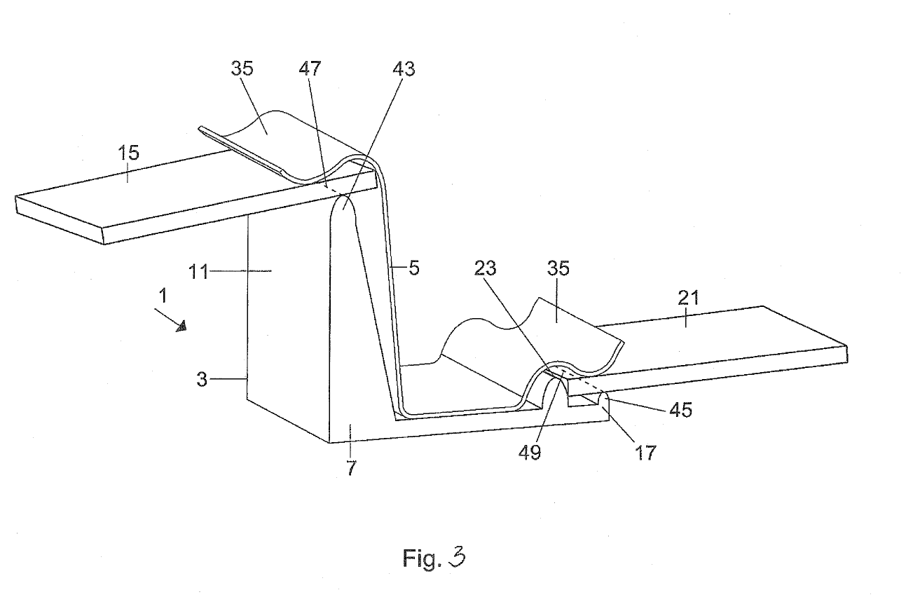

In FIGS. 2 and 3, identical elements are indicated with the same reference symbols. These two embodiments can particularly be used with flexible module rails. For example, if the aforementioned flat iron is used as a module rail, then more or less pronounced bending occurs, which changes under the influence of wind and snow loads and depends on the tension and the effect of the tensile load on the ends of the flat iron. The photovoltaic modules will change their position on the clamps commensurate with bending of the flat iron, which may cause the modular edge to chafe on one of the supporting surfaces. Chafing can be prevented by configuring the supporting surface 13 according to FIG. 2 so that the supporting surface 13 forms a supporting point 41 at the contact location with the photovoltaic module. The photovoltaic module 15, 21 is freely pivotable about the supporting point 41, 42, thereby eliminating any noticeable friction effect when the module rail 9 is bent.

The variant illustrated in FIG. 3 represents an optimal compromise between the embodiments according to FIGS. 1 and 2. The actual contact between the supporting surfaces 13, 19 and the photovoltaic module 15, 21 is in this embodiment neither across an area nor at a point, but rather along a line. The supporting surface 13, 19 of the base 3 has includes here a raised cylindrical portion 43, 45. When a photovoltaic module 15, 21 is placed on the raised cylindrical portion 43, 45 and pressed against the raised cylindrical portion 43, 45 by the bracket 5, a supporting line 47, 49 is created which has neither the high point load associated with the embodiment of FIG. 2, nor the surface chafing effect associated with the embodiment according to FIG. 3.

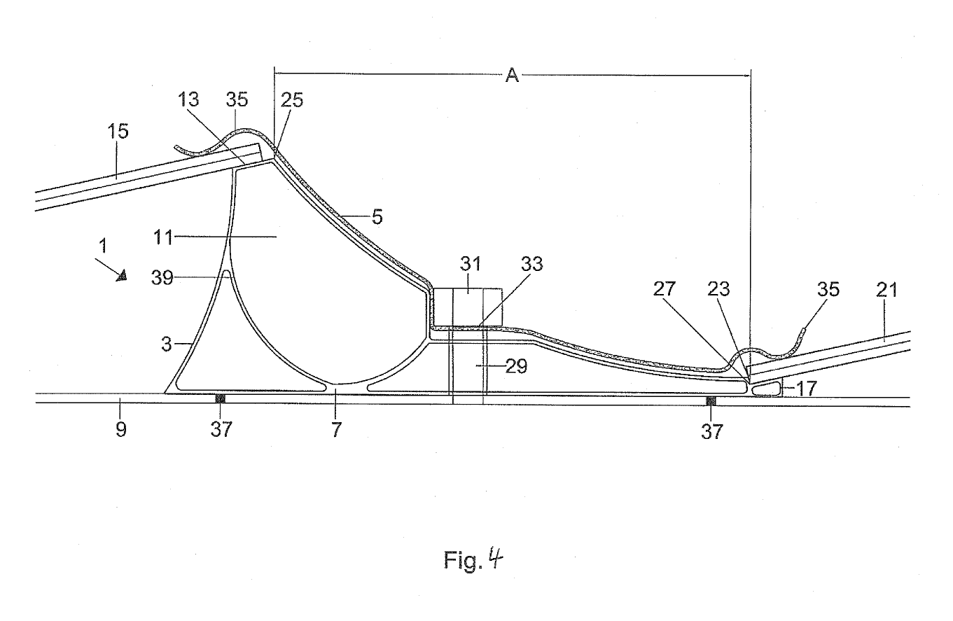

The first and second supporting surfaces 13, 19 (supporting point, supporting line) can be formed on a base 3 of any shape, as shown in FIG. 4, where identical elements have the same reference symbols.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

1. A clamp for inclined attachment of rectangular photovoltaic modules on a module rail, with an upper edge of a first photovoltaic module mounted at a greater height than a lower edge of a second photovoltaic module, the clamp comprising:
a base having a bottom side and a first support constructed to receive the upper edge of the first photovoltaic module and a second support constructed to receive the lower edge of a second photovoltaic module,
a bracket constructed to attach the upper edge of the first photovoltaic module to the first support and to attach the lower edge of a second photovoltaic module to the second support,
wherein the first and the second support are each implemented as at least one of a supporting surface, a supporting line or a supporting point, and
wherein the first and the second support, when projected onto the bottom side, are spaced from each other, so that a higher marginal region of the first support has a predetermined spacing to a lower marginal region of the second support, thereby inclining of the photovoltaic module with the bracket.

2. The clamp of claim 1, wherein the first and second supports comprise first and second supporting surfaces having identical inclination, wherein the second supporting surface for the bottom module edge of the second photovoltaic module comprises a shoulder configured as a limit stop.

3. The clamp of claim 2, wherein the shoulder has a height which is smaller than a height of the photovoltaic module to be installed.

4. The clamp of claim 3, wherein the height of the shoulder is between 3 and 8 mm.

5. The clamp of claim 1, wherein the first and the second supporting surface each comprise an edge oriented parallel to a respective edge of a photovoltaic module or that the first and the second supporting lines are each oriented parallel to the respective edges of a photovoltaic module.

6. The clamp of the claim 1, wherein the base comprises an opening disposed in a region of the predetermined spacing between the higher marginal region and the lower marginal region, and a screw or rivet passing through the opening for attaching the clamp on the module rail.

7. The clamp of the claim 1, wherein the bracket has two ends, with a first of the two ends applying a spring force to the first support and the second end applying a spring force to the second support.

8. The clamp of the claim 1, wherein the base comprises cross braces.

9. The clamp of the claim 1, further comprising a raised portion which protrudes from the bottom side of the base, wherein the bottom side of the base is otherwise planar.

10. The clamp of the claim 1, wherein the module rail comprises at least one of a flat band, a flat iron, and a plastic band, and wherein the clamp has a width identical to a width of the module rail.

11. The clamp of the claim 1, further comprising at least one integrated cable clamp assembly.

12. The clamp of the claim 1, wherein the bottom side is configured for attachment to a rope.

13. A method for producing a base for a clamp, wherein the clamp is configured for inclined attachment of rectangular photovoltaic modules on a module rail, with an upper edge of a first photovoltaic module mounted at a greater height than a lower edge of a second photovoltaic module, the clamp comprising:
a base having a bottom side and a first support constructed to receive the upper edge of the first photovoltaic module and a second support constructed to receive the lower edge of a second photovoltaic module,
a bracket constructed to attach the upper edge of the first photovoltaic module to the first support and to attach the lower edge of a second photovoltaic module to the second support,
wherein the first and the second support are each implemented as at least one of a supporting surface, a supporting line or a supporting point, and
wherein the first and the second support, when projected onto the bottom side, are spaced from each other, so that a higher marginal region of the first support has a predetermined spacing to a lower marginal region of the second support, thereby inclining of the photovoltaic module with the bracket, the method comprising the steps of:
producing a continuously cast rod with a profile matching a cross-section of the clamp, and
cutting the continuously cast rod into disks.
